(19) United States
(12) Patent Application Publication
(10) Pub. No.: US 2020/0311686 A1
(43) Pub. Date: Oct. 1, 2020

(54) METHOD AND SYSTEM FOR MANAGING MARKETERS AND INFLUENCERS

(71) Applicant: Suvita CHARANWONG, Bangkok (TH)

(72) Inventor: Suvita CHARANWONG, Bangkok (TH)

(21) Appl. No.: 16/614,130

(22) PCT Filed: May 16, 2018
(86) PCT No.: PCT/TH2018/000024

§ 371 Date: Nov. 15, 2019

(51) Int. Cl. G06Q 10/10; G06Q 10/06; G06Q 20/10

(52) U.S. Cl. CPC G06Q 10/1053; G06Q 10/063112; G06Q 50/01; G06Q 20/10; G06Q 10/109

(57) ABSTRACT

A method and a system for managing marketers and influencers as described in this invention run a processing system and its supporting apparatuses, comprising a recording process, the first sequence, identifying the marketer's job details by credits, wherein the recording process shows screening alternatives for screening influencers. The second sequence of this invention is to match the jobs and the influencers according to the screening at the early stage. The matching procedure consists of sending and representing the alternatives for preferring jobs on the influencer's client apparatuses, wherein the formerly processing system is responsible for gathering social media data from the representation of the job description on the influencer's client apparatuses. The last sequence of the invention is to create the reports and transferring credits into the influencers received jobs from the job databases, wherein the processing unit operates a series of databases and the credit management unit.

### FIELD OF THE INVENTION

The invention relates to the field of Engineering in parts related computer engineering, management, matching between marketers and influencers able to evaluate the matching. Internet

### BACKGROUND OF THE INVENTION

At the present, it is the era of information that everyone who is able to reach the internet can access everything happened around the world. It is show the cruciality of online databases which contain almost all branches of knowledge like education, medicine, and business. Particularly, online marketing is the term coming to us in every day. There are abundant ideas about business, marketing, and contents expressed on social media today. The exchange of business ideas to reach a mutual agreement is the very important point for all stakeholders such as a creator, a marketer, and an influencer. In the patent circles, the related inventions are filed to be protected about connection between a system and social media and its instruction able to gather idea expressions or voting procedures in order to analyze marketing data in a given field.

The UK Patent application 1512512. 3 describes systems and methods involving in monitoring social media posts and important responses, wherein there are both identifications and monitoring of negative and positive issues posed relevant to a brand. Moreover, the invention includes monitoring the posts on social media involving in a product and one or more competing products to compare the important points of the products.

The US Patent publication US 2016/0019579 A1 explains a system and method for coordination communication between an advertiser and consumers in connection with an influencer campaign via social media. The invention evaluates the effectiveness of an influencer campaign and influencers participating in an influencer campaign. Importantly, the invention help an influencer to gather and stores social media data used to evaluate how well his campaign has reached consumers as well as measure the reach of influencers.

The PCT application PCT/KR2017/004321 describes an apparatus and method for managing matching between a sponsor and an influencer. The invention comprises a set of units namely a database unit, a purchasing requisition unit, an influencer management unit, and advertisement unit, wherein the database unit stores information of an influencer, the purchasing unit receives an influencer search condition from a sponsor, the influencer management unit calculates the scores of the influencer relying on the information and the condition from the previous unit, and releases the proper influencer and influencer lists for the sponsor to support them, and the advertisement production unit sends an advertisement proposal to the selected influencer and manages the advertisement made by the selected influencer.

Additionally, there are some patent applications related to the expression of ideas, marketing, working on social media, analyzing, as well as mutual working among creators, influencers, marketers, and followers as described in patent application US 20150348216 A1 explaining the analysis platform of creators on social media, patent application US 20170064354 A1 manifesting creator's profile made in forms of monitoring the possibility of ideas from users or viewers, the invention explaining a survey of follower's numbers for creator's scores in accordance with patent application US 20150066948 A1, and the inventions related to the marketing programs comprising the campaign management easy to use and showing contacts to users with prompt In-depth analysis in accordance with patent application US 20140279038 A1, CA 2837937 A1 and US 20160034974 A1.

However, a system and method according to this invention are made for solving the flaws mentioned above. The invention is a platform for expressing ideas of creators and marketers by helping the creator who needs to show his novel ideas on not only on obsolete websites, but on other forms of media like Facebook, Twitter, and Instagram. Furthermore, there have been making conversations conveniently among the creators, the influencers, and the marketers about a given product. Furthermore, the system and the method help marketers with instructing a large group of influencers at once with the Micro targeting technology by clicking. Particularly, the marketers are capable of choose the appropriate influencers by considering essential marketing objectives, such as expertise, the number of followers, and engagement rates. The early platform is made for creating brand contents, wherein the marketers can choose to employ jobs by at least one form of online communications such as content-sharing, reviewing, and video review.

### SUMMARY OF THE INVENTION

Accordingly, the present invention is directed to a method and system for managing marketers and influencers in accordance with this invention run a core processing system and its supporting apparatuses, comprising a recording process, a job-and-influencer matching process, a report making process and a credit transferring process.

The recording process identifies the marketer's job details by credits, wherein the recording process shows screening alternatives for screening influencers.

The second sequence of this invention is to match the jobs and the influencers according to the screening at the early stage. The matching procedure consists of sending and representing the alternatives for preferring jobs on the influencer's client apparatuses, wherein the formerly core processing system is responsible for gathering social media data from the representation of the job description on the influencer's client apparatuses.

The last sequence of the invention is to make the reports and transferring credits into the influencers received jobs from the job databases, wherein the core processing unit operates a series of databases comprising social network data, the influencer's personal data, job's databases, and the credit management unit.

The purpose of this invention is to create a platform for marketers and influencers to work with each other in more comfortable ways.

In accordance with the invention, the marketers are able to assign a floc of the influencer's jobs at one time by choosing proper influencers with the consideration of at least one aspect of essential marketing objectives, such as expertise, the number of followers, and engagement rates. In other words, the invention is made the platform for creating sustainable brand content's making.

In conclusion, there are ample benefits beyond various related arts involving in a system and method for co-ordination communication between an advertiser or marketer, an influencer, and consumers or a user in social connection with via social media.

### BRIEF DESCRIPTION OF THE INVENTION

Embodiments of the invention are illustrated by way of example and not by way of limitation in the figures of the accompanying drawings, which are included to provide a further understanding of the invention together with the description served to elaborate the principle of the invention so that it may be more fully understood. In the drawings:

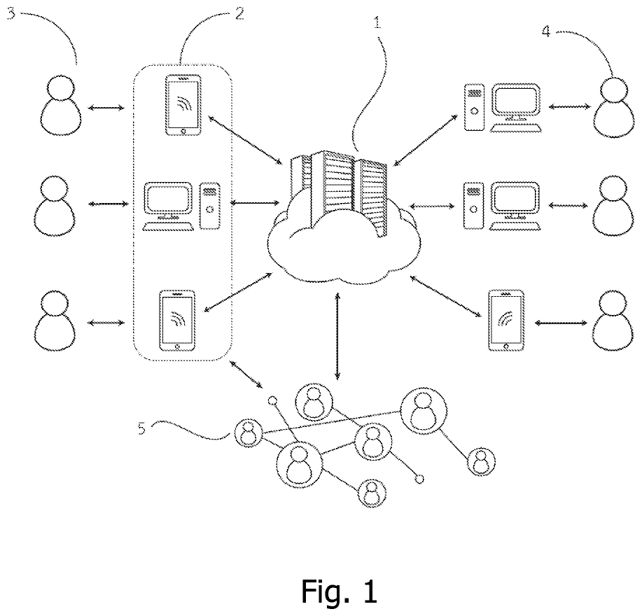

FIG. 1 schematically illustrates an example of relations among the core processing unit, client, and social media.

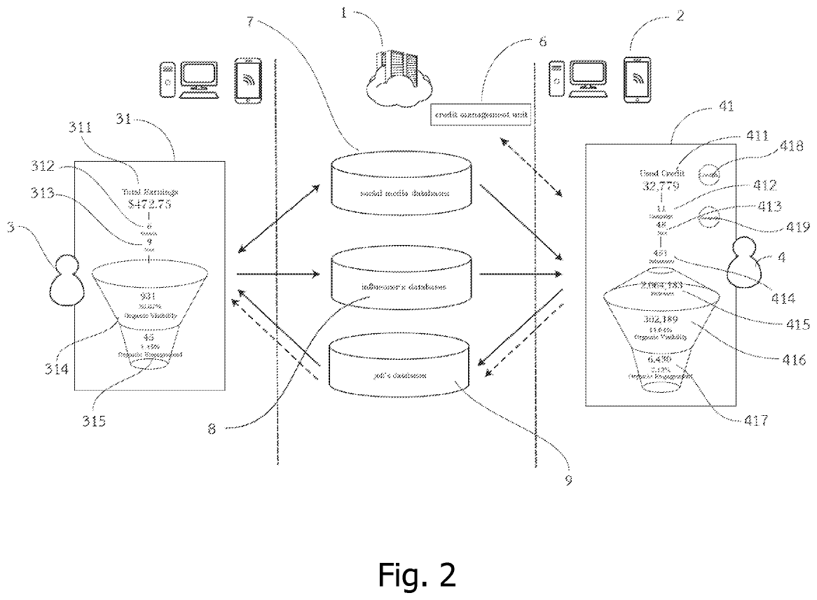

FIG. 2 schematically illustrates an example of a system for managing marketers and influencers.

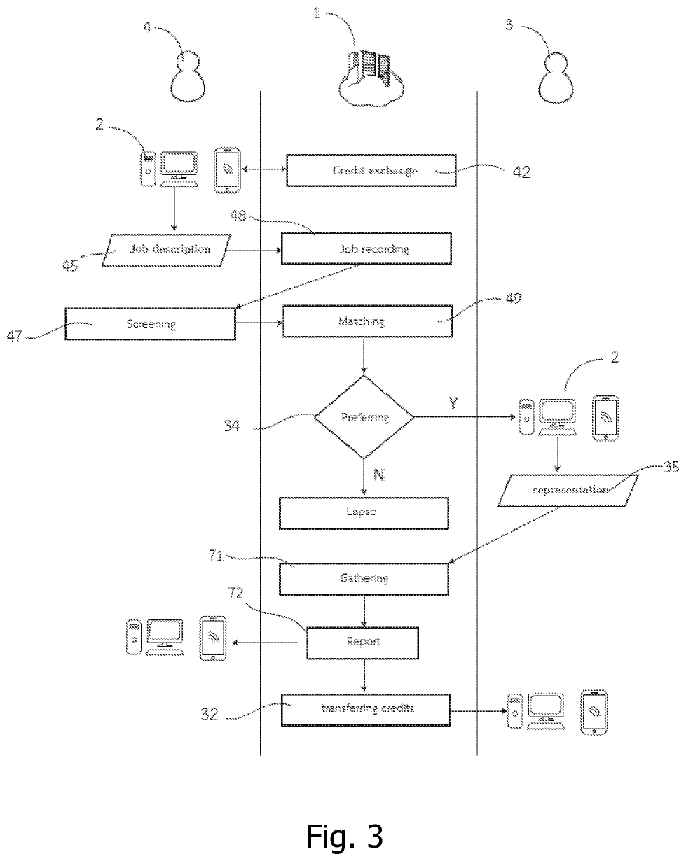

FIG. 3 schematically illustrates an example of a method for managing marketers and influencers.

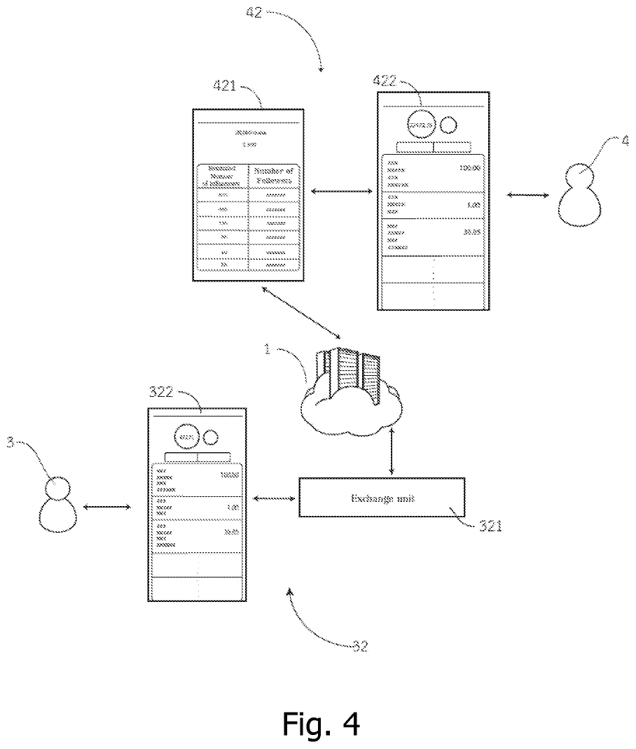

FIG. 4 schematically illustrates an example of credit exchange and credit transferring.

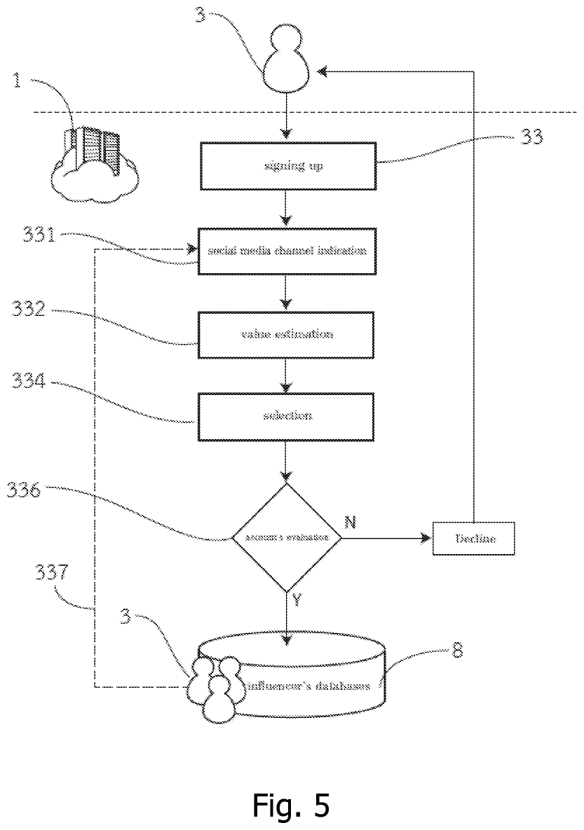

FIG. 5 schematically illustrates an example of signing up processes for managing marketers and influencers.

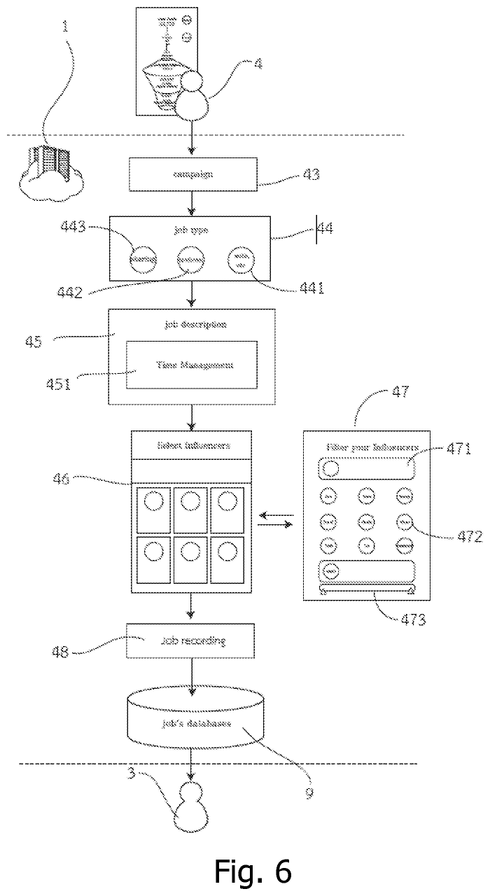

FIG. 6 schematically illustrates an example of job recording into the system for managing marketers and influencers.

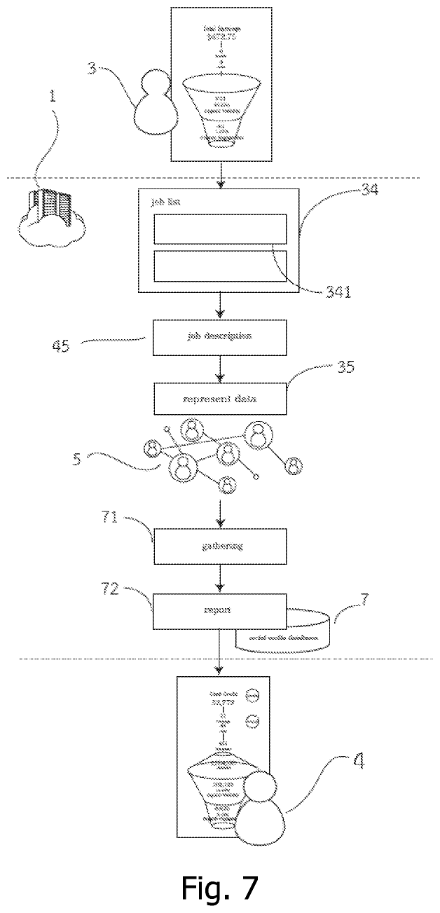

FIG. 7 schematically illustrates an example of preferring job processes on the system for managing marketers and influencers.

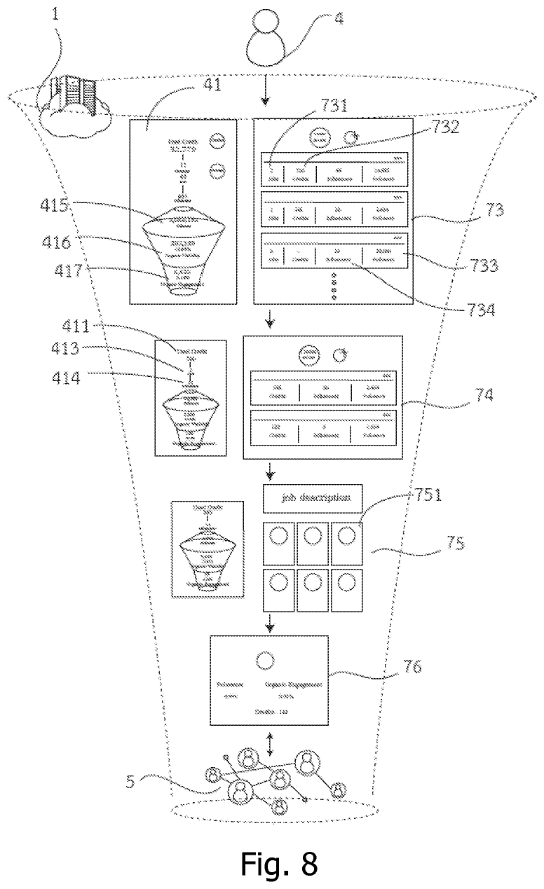

FIG. 8 schematically illustrates an example of the data representation units of the system for managing marketers and influencers.

### DETAILED DESCRIPTION OF THE INVENTION

FIG. 1 schematically illustrates an example of relations among the core processing unit, client, and social media managing at least one part of the core processing unit 1, mutually running in the aspect of a server connecting at least one client apparatus 2 comprising:

a representation unit; and a processing unit like those in a computer or a smart phone, wherein being the client apparatuses 2 of influencers 3 at least one of the client apparatuses 2 of marketer 4 by the influencers 3, including a person having one form of social media accounts, where the marketer 4 refers to a person would like to advertise or communicate some messages throughout other people in one form, and the core processing unit 1 creates the access to social media 5 of the influencers 3 from social media providers linked to the system for managing marketers and influencers.

FIG. 2 schematically illustrates an example of a system for managing marketers and influencers, wherein the said system is comprised at least one unit of the core processing units 1, and the client apparatuses 2, wherein the former 1 made up of social media databases 7 recording the activities or performances of influencer's data representation 3 on social media 5 and influencer's databases 8 recording social media data 5 of the influencers 3 from the social media providers connecting with the invention's system and job's databases 9 recording the marketer's jobs 4 from job's recording and a credit management unit 6 for exchanging credits between the system and the marketers 4 which the credits are the centralized unit for exchange,

in which the system for managing marketers and influencers consisted of a marketer's data representing unit 41 on the client apparatuses 2 linked to the influencer's databases 8, the social media databases 7, the job's databases 9, and the credit management unit 6 which conduct one part of the marketer's data representing units 41 to connect with alternatives for credit exchange 418 for the beginning of the credit exchange 42 associated with job creation and creating job's alternatives 419 for executing job recording and showing at least one part of the follower's data 415, the number of content-witnessed followers 416, reply's numbers of the content-witnessed followers 417 of the marketers 4, in which one of the shown exemplar is demonstrated as the sum of the follower's numbers 415, the sum of the content-witnessed follower's numbers 416, the sum of the reply's numbers by content-witnessed persons 417 derived from the social media databases 7 recording the activities or the achievement of the influencer's data representation 3,

wherein the said system is provided the influencer's data unit 31 on the client' apparatuses 2 by means of allying to the influencer's databases 8, the social media databases 7, and the job's databases 9 where the said data unit manifests the preferring job's choices 34, for picking jobs from the databases 8, and linking at least one part of gained credit's data numbers 311.

Nevertheless, the marketer's data representing unit 41 displays additional data in at least on part of used credits 411, campaigns 11 presenting jobs or a group of job types, the influencer's numbers 414, or the influencer's data unit 31 which shows at least one part of the content-witnessed follower's numbers 314, the reply's numbers of content-witnesses 315 obtained from the social media databases 7 recording the activities or performances of the influencer's data representation 3, or supplying the influencer's data unit 31 with additionally displaying at least on part of job number's data 313, brand's numbers 312 divided by the marketers 4 in the conditions of company lists or one form of advertisement target sorts.

FIG. 3 schematically illustrates an example of a method for managing marketers and influencers, in which the said method is run at least one unit of the core processing units and the client apparatuses comprise:

job recording 48 by means of defying job description 45 where one of its aspect is acquired at least one part of campaign names, product's names, brief job descriptions, file's or website's addresses, periods of opening job's alternatives by identifying job descriptions 45 proceeded from the client apparatuses 2 of the marketers 4 with the forms determined by the said system, wherein the jobs are defined credit numbers by the credit exchange 42. However, the mentioned exchange is defined at least in the aspects of a specific pattern and/or a range of credits;

screening alternative's representation 47 indicating the alternatives screening influencers 3 according to credit numbers' defining or other factors having been explained, in the following order, on the client's apparatuses 2 of the marketers 4 to attract the most appropriate influencers 3 in conformity with the job description's objectives 45;

job-and-influencer matching 49 pairing the in-system jobs and the influencers 3 from the influencer's databases 8, in accordance with appointed screening by the influencers 3, and sending the job descriptions to the influencers by the said screening;

representation of alternatives for preferring jobs 34 supplying and showing the alternatives for preferring jobs on the client apparatuses 2 of the influencers 3, in which the influencer's client apparatuses 2 are displayed at least one of preferring job's alternatives, for example, a not-preferring job from the job choices 34 will expired when it's out of time of that job, or displayed a rejected button for deleting a job preferring choice 34 from the influencer's client apparatuses 3;

information gathering 71 assembling the social media data 5 of data representation 35 related to the job descriptions 45 from the social media providers on job's database 9;

report making 72 from the information gathering 71 performing at least one status of the follower's numbers 415, the content-witnessed follower's numbers 416, the reply's numbers 417 on the client apparatuses (2) of the marketers (4) presenting in the aspects of the sum, or separating by the campaign lists, and/or jobs, and/or the influencers, or one of them for evaluating the effectiveness of its data representation 35, wherein the said representation 35 stands for communication involving in job descriptions on social media 5; and

credit's transferring 32 to the influencers 3 preferring jobs from their databases 9, took place when the influencer's execution 3 meets the criteria defined by the invention's system and method and/or by the marketers.

FIG. 4 schematically illustrates an example of credit exchange and credit transferring, wherein the credit unit is defined to be an exchange unit for this invention's system and method without prescribing the exact number of its patterns, comprising one of the following patterns; codes, cards, member's scores, or the exchange of general currencies, or digital currencies where the credit exchange 42 is determined as transferring one unit of the marketer's units 4 into credit's units instead,

wherein the said exchange 42, or the system as described in this invention is additionally made up of a credit association unit 422 illustrating at least one part of exchange history representation, or the sum of credits, or the sum of units exchanged, or the credit's exchange method 42, or the system as mentioned including an estimating unit 421 exhibiting the relations of the credit's numbers, the influencer's numbers, and the follower's numbers for showing credit numbers exchanged 42 in which the influencers are able to make, and/or the number of the followers earned from that credit numbers. However, the proper credit transferring 32 is the transferring operating the unit exchange 321 translating credits to match with a received account's unit 322, wherein the influencers 3 have association with the said system and method, or display the exchange history, or the sum of credits, or the sum of units exchanged without limiting the number and/or types of received accounts 322.

FIG. 5 schematically illustrates an example of signing up processes for managing marketers and influencers according to the invention, in which the screening alternative's representation 47, or the job-and-influencer matching 49 is run on the influencers 3 signing up 33 via the client apparatuses 2 by which operated the core processing unit 1, additionally comprising:

social media channel indication 331 illustrating choices for identifying a variety of channels, such as Facebook, Instagram, and Twitter wherein the social media of this invention refer to a given channel that the influencer 3 reacts with others' accounts, which 3 be able to add channels 337 later;

value estimation of posts 332 estimating the value of user accounts which is one of choices to set up criteria and the screening alternative's representation 47 assessing from the reactions of influencer's accounts 3 in the form of credit or the same unit as the user account does 322, wherein the influencers 3, in one aspect, conduct the estimation from at least one of the following variables namely, the number of followers 415, the content witnessed follower's numbers 416, and the number of replies 417;

field of interest's selection 334 regulating the influencers 3 to indicate the field of their interests by picking up at least one of the following activities or sorts of interests, such as food, news, beauty and cosmetics, travel, health and exercise, movies and music, technology, investment, and arts, wherein there is no limitation of choosing activity patterns, or the fields of interests' numbers and/or the areas or territories the influencers 3 using social media living in 5 like home country, or continent; and

user account's evaluation 336 auditing the user accounts via the client apparatuses 2 to identify whether the account satisfies the defined criteria, or the defined method, wherein there are the two alternatives namely approved and disapproved, if it passes this evaluation process 336, the influencer's data 3 are recorded in the said system to display alternatives for the marketers chronologically 4.

FIG. 6 schematically illustrates an example of job recording into the system for managing marketers and influencers, which job description's identification 45 is carried out by the core processing unit 1 comprising:

campaign launching 43 connecting with one part of the client apparatuses 2 of the marketers 4 for the beginning of job making, or the campaign launching being a sort of job categories;

job category selection 44 chosen from at least one part of content sharing 443, reviews 442, auditory media and/or motion pictures 441 boundless to select the previously, wherein each job category is regulated to have a distinctive job description 45, characterizing in that the said distinctive job description 45 comprises a time management system 451 operating that the marketers 4 are able to assign the exact day to do the job according to its description, specify the period of time to gather information 71 for evaluating data representation 35. For instance, there is a specific time or day when the marketer has to submit a job to an influencer 3, when the influencer 3 has to make a decision to prefer the job, when the influencer 3 has to represent the data 35 on social media 5, and a period of time to gather information 71 for making a report 72; and

influencer indicating 46 displaying the influencers 3 recorded on the influencer's databases 8 providing the screening alternatives 47, wherein the alternatives are chosen from at least one of the following conditions, area specification 471, the field of interest's indication 472 in accordance with a category of activities or interests like those in the field of interest's selection 334, credit's numbers' defining 473 in terms of its ranges or exact credit numbers, wherein the system and method regulates the determined the job-and-influencer matching 49 by screening alternatives 47 to correspond with the value estimation of posts 332.

FIG. 7 schematically illustrates an example of preferring job processes on the system for managing marketers and influencers, which the influencers 3 in the influencer's databases 8 of the system regulate alternatives for preferring job 34 from job databases 9 conforming to the condition where the marketers 4 defined by the screening alternatives 47, wherein the preferring job alternatives 34 display at least one job list 341 illustrating or associating with at least one part of job description 45, and wherein each job list 341 demonstrates in the form of credit or the same unit as the influencer's accounts do 332, when the influencers 3 prefer jobs and represent data 35 on social media 5, the system gather data and make the job lists 72, comprising at least one part of the used credit's numbers 411, campaign's numbers 412 illustrating a group of job categories, and the influencer's numbers 414.

FIG. 8 schematically illustrates an example of the data representation units of the system for managing marketers and influencers, wherein the system of this invention helps the marketers 4 make assessments for planning or advertising showing both overall data and separated level data from marketing activity-level to influencer-level. An example of this invention is to make the marketer's data representing unit 41 connect to a marketing activity-level data representing unit 73, making up of at least one campaign 73, wherein the said marketing activity-level unit linking to a campaign-level data representing unit 74, containing at least one job, wherein the said campaign-level unit 74 show or links to a job-level data representing unit 75, which each the said job-level unit 75 manifests each of influencer-level data representing unit 76, the said system assist the marketers with looking precisely at both the operation and audit from the overall process level to the least activity, wherein each level is displayed as followed:

the marketer's data representing unit 41 comprising of or attaching to at least one part of job numbers 731, credit numbers 732, the influencer numbers 734, the follower numbers 733 divided by the campaign names;

the campaign-level data representing unit 74 comprising or connecting with at least one part of credit numbers 732 categorized by job names, the influencer's numbers 734 categorized by job names, the follower numbers 733 categorized by job names, the sum of the used credit numbers 411, the sum of the follower numbers 415 of the entire jobs, the sum of the content-witnessed follower numbers 416 of the entire jobs, and the sum of replies 416 of the entire jobs;

a job-level data representing unit 75 comprising or associating all influencer's personal data 751 in total categories of jobs, wherein the said unit comprising at least one part of the sum of the used credit numbers 411 of every influencer, the sum of the follower numbers 415 of every influencer, the sum of the content-witnessed follower numbers 416 of every influencer, and the sum of the reply numbers 416 of every influencer; and

the influencer's personal data 751 of every person in a job category involving in an influencer-level data representing unit 76 comprising at least one part of the follower numbers 415 divided by each influencer 3, the reply numbers 417 divided by each influencer 3, wherein influencer-level data 76 show the user accounts of the influencers 3 on social media 5 demonstrated data representation 35.

Although the present invention disclosure has been described above, it may be clearly understood, improved, or changed by those skilled in the art under the scope and the objectives of the invention as disclosed in the claims.

1. A method for managing marketers and influencers running at least one unit of processing units and at least one of its client apparatuses comprising:
recording job (48) indicating job description (45) from the said client apparatuses (2) of marketers (4), characterized in that a job is defined credit's numbers by credit exchange (42);
representing screening alternatives (47) indicating alternatives screening influencers (3) on the said client apparatuses (2) of the said marketers (4);
matching job and influencer (49) matching in-system jobs and influencers (3) in accordance with appointed screening;
representing alternatives for preferring jobs (34) supplying and showing the alternatives for preferring jobs on the said client apparatuses (2) of the said influencers (3);
gathering information (71) assembling social media data (5) of data representation (35) related to the said job descriptions (45) from social media providers on job's database (9);
making a report (72) from information gathering (71) performing at least one status of follower's numbers (415), content-witnessed follower's numbers (416), reply's numbers (417) displayed on the said client apparatuses (2) of the said marketers (4); and
transferring credits (32) to the said influencers (3) preferring jobs from job's databases (9).

2. The method of claim 1, wherein report making (72) comprises at least one part of used credits (411), and campaigns (412¬) illustrating a series of jobs categories, and influencer's numbers (414).

3. The method of claim 1, wherein the said processing unit (1) connects to data on the said client apparatuses (2) of the said influencers (3) by showing at least one part of credit's number data (311), the number of content-witnessed followers (314), the number of replies coming from the said content-witnessed followers (315).

4. The method of claim 3, wherein the said processing unit (1) connects to data on the said client apparatuses (2) of the said influencers (3) by representing at least one part of job's numbers (313), brand's numbers (312) divided by the said marketers (4).

5. The method of claim 1, wherein the said credit exchange (42) provides an estimating unit (421) exhibiting the relation among the said credit's numbers, the said influencer's numbers, and the said follower's numbers.

6. The method of claim 1, wherein the said credit's transferring (32) provides unit exchange (321) transforming credits into the unit matching with the received account's unit (322).

7. The method of claim 1, wherein the screening alternative's representation (47) displays the choices screening the influencers (3) from a signing up process (33) giving user account's evaluation (336).

8. The method of claim 7, wherein the said signing up process (33) connects to the said user account's evaluation (336) providing social media channel indication (331).

9. The method of claim 7, wherein the said signing up process (33) connects to the said user account's evaluation (336) providing value estimation of posts (332).

10. The method of claim 7, wherein the said signing up process (33) connects to the said user account's evaluation (336) providing field of interest's indication (334).

11. The method of claim 1, wherein job description's indication (45) provides job category selection (44) chosen at least one part of content sharing (443), reviews (442), auditory media and/or motion pictures (441).

12. A system for managing marketers and influencers comprising:
at least one part of the processing units (1);
one of its client apparatuses, comprising databases made up of social media databases (7) and influencer's databases (8) recording the social media data (5) of the influencers (3) from social media providers, the job's databases (9) recording marketer's jobs (4) and a credit management unit (6) placed in the said processing unit (1), characterized in that the said client apparatuses (2):
connecting to the said influencer's databases (8), the said social media databases (7), the said job's databases (9), and the said credit management unit (6), contains a marketer's data representing unit (41) displaying credit exchange alternatives (418), creating job alternatives (419), at least one part of the data of the follower's numbers (415), the number of the content-witnessed follower's reply, and the reply's numbers of the content-witnessed followers (417); and
connecting to the said influencer's databases (8), the said social media databases (7), and the said job's databases (9), contains an influencer's data unit (31) displaying the alternatives for preferring jobs (34) and connecting to at least one part of earned credit numbers' data (311); and

13. The system of claim 12, wherein the said marketer's data representing unit (41) displays at least one part of the used credits (411), the number of campaigns (11) presenting a floc of job categories, and the influencer's numbers (414).

14. The system of claim 12, wherein the influencer's data unit (31) displays at least one part of the content-witnessed follower's numbers (314), and the said reply's numbers (315) of content-witnesses.

15. The system of claim 12, wherein the influencer's data unit (31) displays at least one part of job's numbers (313), and brand's numbers (312) separated by the marketers (4).

16. The system of claim 12, wherein the credit management unit (6) displays the estimating unit (421) exhibiting the relations of the credit's numbers, influencer's numbers, and the said follower's numbers.

17. The system as of claim 12, wherein the processing unit (1) provides the said unit exchange (321) transforming credits into the unit matching with the received account's unit (322).

18. The system of claim 12, wherein the marketer's data representing unit (41) connects to Marketing activity-level data representing unit (73) decided to be comprised at least one part of job's numbers (731), the credit's numbers (732), influencer's numbers (734), and the said follower's numbers (733) divided by a campaign.

19. The system of claim 18, wherein the marketing activity-level data representing unit (73) comprises a campaign-level data representing unit (74) comprising at least one part of the credit's numbers (732), the number of influencers (734), and the number of the said followers (733) categorized by a job.

20. The system of claim 19, wherein the campaign-level data representing unit (74) comprises at least one part of the sum of the said used credits (411), the said follower's numbers (415), the said content-witnessed follower's numbers (416), the said reply's numbers (416) of the entire jobs.

21. The system of claim 19, wherein the campaign-level data representing unit (74) comprises a job-level data representing unit (75) comprising all influencer's personal data (751) in total categories of jobs.

22. The system of claim 21, wherein the job-level data representing unit (75) comprises at least one part of the said used credit's sum (411), the said follower's numbers (415), the said content-witnessed follower's numbers (416), and the said reply's numbers (416) of the entire influencers.

23. The system of claim 21, wherein the influencer's personal data (751) of every person in all said job categories links to an influencer-level data representing unit (76) comprising at least one part of the said follower's numbers (415), and the said reply's numbers (417) divided by each influencer (3).

24. The system of claim 23, wherein the influencer-level data representing unit (76) displays the influencer's user account (3) on the said social media (5) representing the data (35) as the marketers were appointed.

25. The system of claim 12, wherein job's databases (9) record the jobs of the marketer (4) comprising a time management system (451) characterized in that the marketer (4) is able to specify the period of time for the influencer to gather information (71).

26. The system of claim 12, wherein job's databases (9) record the jobs of the marketer (4) comprising a time management system (451) characterized in that the marketer (4) is able to specify at least one period of time for the influencer (3) to prefer the job, and to represent the data (35) on social media (5), as well as for the marketer to submit a job to the influencer (3).
